(19) United States
(12) Patent Application Publication
(10) Pub. No.: US 2016/0049084 A1
(43) Pub. Date: Feb. 18, 2016

(54) HEALTH INFORMATION PROCESSING NETWORK

(71) Applicant: EdLogics, LLC, Virginia Beach, VA (US)

(72) Inventors: Thomas M. Chamberlain, Virginia Beach, VA (US); Steven Bauwens, Virginia Beach, VA (US); Jerry T. Gulley, II, Pleasant Prairie, WI (US)

(21) Appl. No.: 14/828,154

(22) Filed: Aug. 17, 2015

Related U.S. Application Data
(60) Provisional application No. 62/037,965, filed on Aug. 15, 2014.

(51) Int. Cl. G09B 7/06; G09B 19/00

(52) U.S. Cl. CPC G09B 7/06; G09B 19/00

(57) ABSTRACT

A health information processing network having: a processing system configured to present a first health related inquiry accessible through user devices together with alternative responses including: a) a first correct response to the first health related inquiry; and b) a second incorrect response to the first health related inquiry; and a plurality of user devices each configured to allow a user to: i) identify the first health related inquiry and alternative responses; and ii) input a selection of one of the first and second responses. The processing system is configured to receive the input selected responses and accumulate each of the input first correct responses with an associate user identify in a first database. The processing system is further configured to: a) provide access to one of the input first correct responses in the first database based upon predetermined access criteria; and b) identify a user associated with the accessed one of the input first correct responses.

### BACKGROUND OF THE INVENTION

1. Field of the Invention

This invention relates to the human health field and, more particularly, to a processing network that is configured to motivate users to educate themselves with respect to health-related topics.

2. Background Art

As purchasing healthcare coverage transitions from a wholesale to a retail marketplace, and as the patient-centered medical home model proliferates, consumers will benefit from becoming better educated and more aware of key issues that will affect both them and their family's health and financial status.

Educational strategies and techniques are needed to guide consumers through an effective educational experience. This experience must be comprehensive and should include principles of learning theory, organized and effective educational curriculum design, and unique incentive strategies and tactics that motivate individuals to explore, discover, and continue to learn about key health issues.

Employers, payers, government agencies, foundations, special interest groups, and other organizations should strive to effectively convey important health information to the American public in a credible, easy to comprehend, and engaging manner, and to a worldwide population when appropriate. Awareness and knowledge about important health care issues will increase participation in health improvement programs and services. Overall health improvement of employees reduces medically related absences while improving productivity and efficiency, which makes businesses more viable and profitable.

Individuals follow a relatively standardized pathway when dealing with any health issue. An initial preventative phase leads into a symptomatic period, which in turn leads to a diagnostic stage, which typically involves interaction with a health professional. This is followed by a treatment period, which can become cyclical as many individuals have to try several specific treatments or perhaps a combination of treatments. At each stage of any condition pathway, a body of critical education points exists that can empower an individual to manage their personal health through lifestyle changes, medication adherence, etc. However, no system exists that affords a large percentage of the population, including persons with different backgrounds, literacy, means, age, etc., convenient and practical access to health related information that could allow them to effectively manage their health through all of the above stages.

### SUMMARY OF THE INVENTION

In one form, the invention is directed to a health information processing network having: A) a processing system configured to present a first health related inquiry accessible through user devices together with alternative responses to the first health related inquiry including: a) a first correct response to the first health related inquiry; and b) a second incorrect response to the first health related inquiry; and B) a plurality of user devices each configured to allow a user to: i) identify the first health related inquiry and alternative responses; and ii) input a selection of one of the first and second responses. The processing system is configured to receive the input selected responses and accumulate each of the input first correct responses with an associated user identity in a first database. The processing system is further configured to: a) provide access to one of the input first correct responses in the first database based upon predetermined access criteria; and b) identify a user associated with the accessed one of the input first correct responses.

In one form, the processing system is configured so that the accessed one of the input first correct responses in the first database is accessed using a random number generator.

In one form, the processing system is configured to relate a return awarded to the user associated with the accessed one of the input first correct responses based upon programmed criteria.

In one form, the processing system and user devices are configured so that the health related inquiry and first and second responses are displayed on an image of a scratch card.

In one form, the return awarded is one of: a) a specific dollar amount; b) a discount on a health insurance premium; c) a discount on a health related product; and d) a discount on a health related service.

In one form, the processing system is further configured to accumulate each of the input second incorrect responses with an associated user identity in a second database. The processing system is further configured to: a) provide access to one of the input second incorrect responses in the second database based upon predetermined access criteria; b) identify a user associated with the accessed one of the input second incorrect responses; and c) relate a return awarded to the user associated with the accessed one of the input second incorrect responses based upon programmed criteria.

In one form, the processing system has a database of information relating to one of: a) general health issues; b) health diagnosis; c) health improvement; and d) health maintenance that is accessible through the plurality of user devices.

In one form, the processing system is configured to provide feedback to users of user devices that input a selection of one of the first and second responses relative to subject matter to which the first health related inquiry pertains.

In one form, the information processing network is configured to present an additional health related inquiry that is processed through the processing system and plurality of user devices in the same way that the first health related inquiry is processed. The processing system is further configured to accumulate an individual user's input first correct responses and assign a status to the individual user based upon a number of the individual user's input first correct responses.

In one form, the information processing network is configured to present an additional health related inquiry that is processed through the processing system and plurality of user devices in the same way that the first health related inquiry is processed. The processing system is configured to assign a value to a particular user's input first correct responses. The value is different for the input first correct responses to different health related inquiries.

In one form, the information processing network has a database of health related inquiries and alternative responses, including the first health related inquiry and alternative responses to the first health related response. The processing system is configured to present multiple health related inquiries and alternative responses from the database either together or separately to be accessible through the user devices.

In one form, the processing system is configured to store accumulated data relating to a particular user's input first and second responses to be accessible through one of the plurality of user devices.

In one form, the processing system is configured to store accumulated data relating to first and second users' input first and second responses and so that the first user can access the accumulated data relating, to each of the first and second users' input first and second responses.

In one form, the processing system is configured to make available to a user a respective awarded return value and related information for accounting and/or tax purposes.

In one form, the processing system is configured so that the predetermined access criteria is based upon a total number of users that have input first correct responses.

In one form, the processing system is configured to determine and display a quantified chance that a particular user will be provided access to one of the first correct responses input by the particular user.

In one form, the information processing network is configured to store educational health information that can be accessed through the plurality of user devices and so that the first health related inquiry is presented to a particular user as an incident of the particular user's accessing the stored educational health information.

In one form, the information processing network is configured to present a number of games that can be played by a user that require a user input that selectively leads to presentation of a health related inquiry.

In one form, the information processing network is configured to be accessed by a public-facing application.

In one form, the information processing network is configured to store educational health information. The information processing network is configured to link a particular user to specific information making up part of the stored educational health information as an incident of the particular user's inputting a selection of one of the first and second responses.

In one form, an information processing network has: a processing system configured to present a first inquiry accessible through user devices together with alternative responses to the first inquiry including: a) a first correct response to the first inquiry; and b) a second incorrect response to the first inquiry; and a plurality of user devices each configured to allow a user to: i) identify the first inquiry and alternative responses; and ii) input a selection of one of the first and second responses. The processing system is configured to receive the input selected responses and accumulate each of the input first correct responses with an associated user identity in a first database. The processing system is further configured to: a) provide access to one of the input first correct responses in the first database based upon predetermined access criteria; and b) identify a user associated with the accessed one of the input first correct responses.

In one form, the invention is directed to a health information processing network having: a processing system configured to present a first health related inquiry accessible through user devices; and a plurality of user devices each configured to allow a user to input a response to the first health related inquiry. The processing system is configured to: a) receive the input responses; b) equate each input response to a value item; and c) accumulate the value items in a first database. The processing system is further configured to: A) provide access to one of the value items in the first database based upon predetermined access criteria; and B) identify a user associated with the accessed one of the value items.

### BRIEF DESCRIPTION OF THE DRAWINGS

FIG. 1 is a schematic representation of a health information processing network, according to the present invention;

FIG. 2 is a flow diagram representation of one configuration of the network to produce a lottery-style format that provides awards to users inputting responses to health related inquiries;

FIG. 3 is a partially schematic, front elevation view of a display showing a digital scratch card through which a user can identify a health related inquiry and input a response thereto;

FIGS. 4-8 are flow diagram representations of various operations that can be carried out using the health information processing network as depicted schematically in FIG. 1;

FIG. 9 is a front elevation view of a display with an image showing status of all users based upon input of responses; and

FIG. 10 is a further flow diagram representation of another operation that can be carried out using the network of FIG. 1.

### DETAILED DESCRIPTION OF THE PREFERRED EMBODIMENT

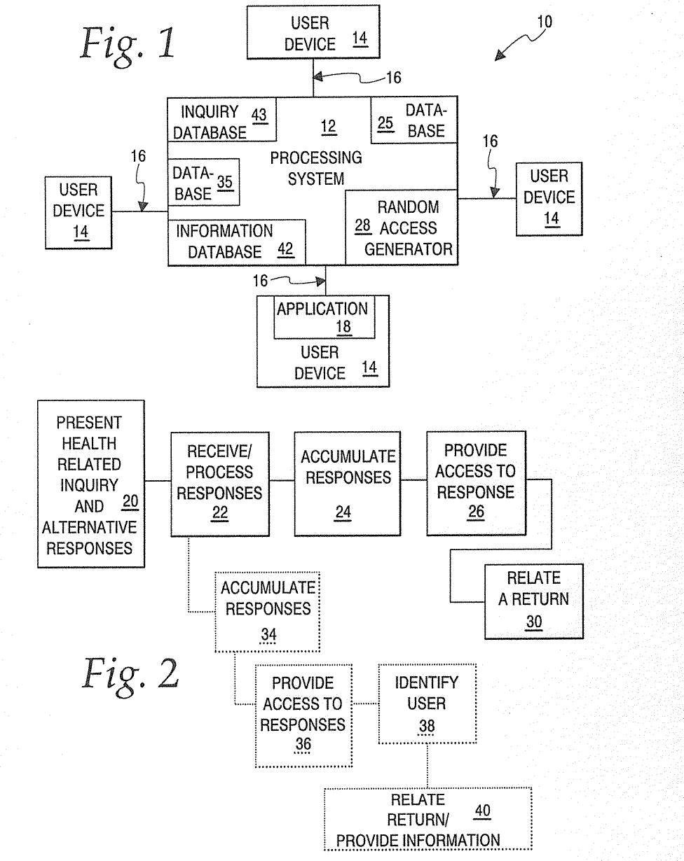

In a preferred form, the invention is directed to a health information processing network as shown schematically at 10 in FIG. 1. The health information processing network 10 consists of a processing system at 12 and a plurality of user devices 14. The processing system 12 defines a platform for network operation. The details of the processing system 12 are not critical to the present invention, with it being understood that the schematic showing of the processing system 12 is intended to encompass virtually all known processing technology, such as microprocessors, integrated circuits, reconfigurable processors, etc.

Each of the user devices 14 may take any known form, such as a mobile device, personal computer, server, PDA, etc. The user devices 14 execute through a network at 16 that may be a local area network, the internet, etc.

The schematic showing of the processing system 12 and user devices 14 is intended to encompass virtually an unlimited number of different components and their interaction. The processing system 12 may be made up of a single component or multiple interacting components, so long as the capabilities as described below are present.

The user devices 14 may be coupled to interact with the processing system 12 through a public-facing application, as shown at 18 in FIG. 1, downloaded to the user devices 14.

The general construction and operation of the health information processing network 10 will be described initially, followed by a description of more detailed operational examples.

The basic operation of the processing system 12 is shown in flow diagram form in FIG. 2. As shown at block 20, the processing system 12 is configured to present a health related inquiry accessible through the user devices 14 together with alternative responses to the first health related inquiry. Normally, the alternative responses will include: a) a first correct response to the first health related inquiry; and b) a second incorrect response to the first health related inquiry. The “incorrect” response may be one that is entirely incorrect or one that is less correct/accurate than the first response.

Each user device 14 is configured to allow a user to: a) identify a first health related inquiry and alternative first and second responses; and b) input a selection of one of the first and second responses. The health related inquiries generally relate to evidence-based health information.

As shown at block 22, the processing system 12 is configured to receive and process each of the responses from the user devices 14.

As shown at block 24, the processing system 12 is further configured to accumulate each of the input first correct responses with an associated user identity in a first accessible database 25 (see FIG. 1).

As shown at block 26, the processing system 12 is configured to: a) provide access to one of the input first correct responses in the first database based upon predetermined access criteria; and b) identify a user associated with the accessed one of the input first correct responses.

The processing system 12 may include a random number generator/random access generator 28 (see FIG. 1) to access the one of the input first correct responses in the first database.

As shown at block 30 in FIG. 2, the processing system 12 is configured to relate a return awarded to the user associated with the accessed one of the input first correct responses based upon programmed criteria. The related return may be an immediate cash award, an assignment of points on a point-based success system, or other type of an award that may have a direct return or apply to a potential or actual future return. A user may earn bonus entries that are instantly applied or apply to a future action. The bonus entries may be assigned based on different criteria—for example, based on difficulty of answer or a user's status based upon historical performance. Performance in a game format may entitle a user to points/bonus entries.

The return awarded may be one of: a) a specific dollar amount; b) a discount on a health insurance premium; c) a discount on a health related product; d) a discount on a health related service; and e) other non-health related product or service. The discount may be a dollar amount, a percentage, or the entire value of the product or service.

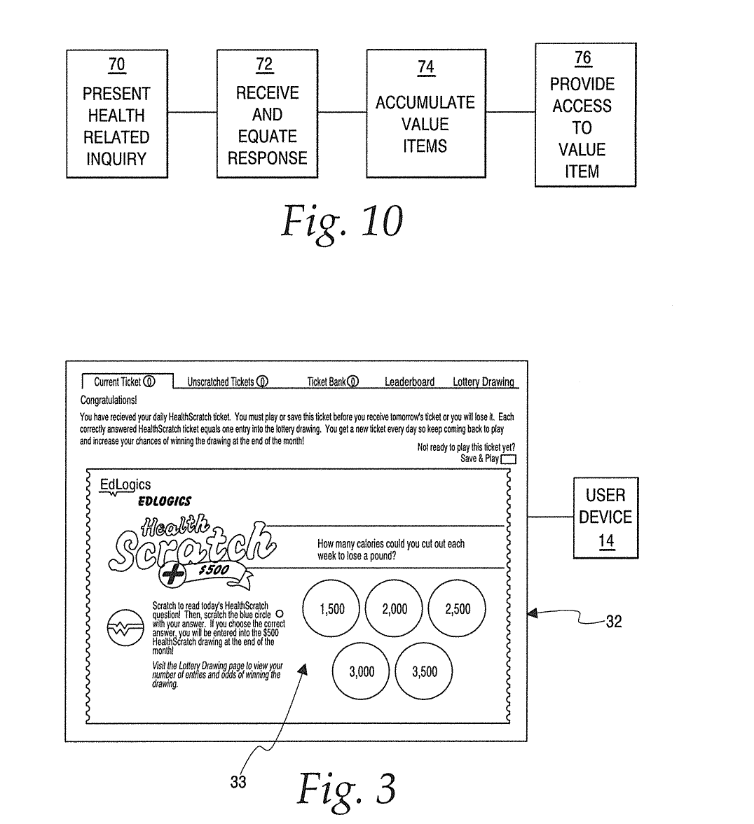

FIG. 3 shows a display at 32, as on one of the user devices 14. The processing system 12 and user device 14 interact and are configured so that the health-related inquiry and first and second responses are displayed on an image of a scratch card at 33. The scratch cards 33 become the digital currency to engage users of the network 10. In this case, the health-related inquiry is “how many calories could you cut out each week to lose a pound?”. As depicted, there are five potential responses (1,500; 2,000; 2,500; 3,000; 3,500), with one of the responses being the correct response.

In an alternative form, or in conjunction with the function described in FIG. 2, the processing system 12 may also allow a user to benefit from selection of incorrect responses. This encourages additional user participation and may also allow the user that selected an incorrect response to be provided with helpful and/or encouraging information, as described below.

As shown at dotted block 34 after processing in block 22, the input second incorrect responses with associated user identities are accumulated in a second accessible database 35 (see FIG. 1).

As shown at dotted block 36, the processing system 12 is configured to provide access to one of the input second incorrect responses in the second database 35 based upon predetermined access criteria.

As shown at block 38, a user associated with the accessed one of the input second incorrect responses is identified.

As shown at dotted block 40, the processing system 12 relates a return awarded to the user associated with the accessed one of the input second incorrect responses based upon programmed criteria. Additionally, or alternatively, information is provided of a nature to educate the user regarding a correct response to the health related inquiry.

The information provided to the user may be stored in an information database 42 (see FIG. 1) that may include information relating to at least one of: a) general health issues; b) health diagnosis; c) health improvement; and d) health maintenance.

The processing system 12 may provide feedback to users of the devices 14 directly inquiring about such information through their device 14. Alternatively, the return of information from the database 42 may be triggered by the input of a selection of one of the first and second responses relative to subject matter to which the first health related inquiry pertains.

While the network 10 has been described with respect to the processing of a single health related inquiry, it is contemplated that the network 10 may have a databank 43 (see FIG. 1) of health related inquiries and alternative responses. The multiple health related inquiries and alternative responses may be presented at the same time or separately to be accessible through the user devices 14. The entity controlling the network 10 may determine the number of health related inquiries and alternative responses offered and their frequency of presentation.

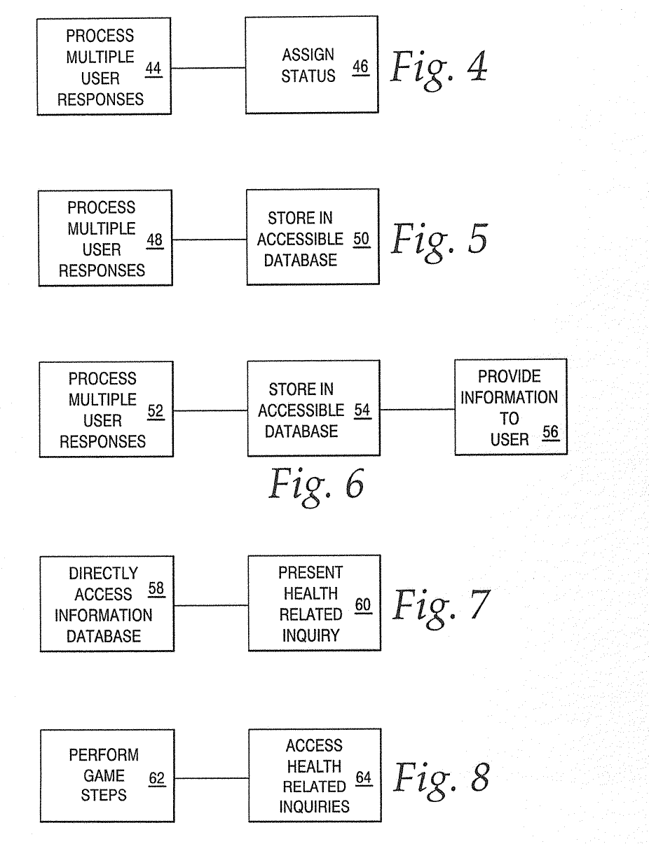

As shown in FIG. 4, at block 44, the network 10 may process multiple responses to health related inquiries from the same or different users and process those responses in different ways. As shown at block 46 in FIG. 4, a user may be assigned a status based upon the number of correct responses made by that user through multiple selections of responses input by that user. The status may be determined by the total number of input first correct responses and/or by the percentage of correct responses selected. The different correct responses input may be weighted based upon the difficulty of the inquiry. This may be factored into the assignment of status for a particular user. This status may entitle the user to certain financial benefits or may entitle him/her to different advantages as different activities are carried out through the processing system 12 beginning with the initial steps described hereinabove.

As indicated in FIG. 5, with multiple user responses processed as at block 48, the processing system 12 may store accumulated data relative to the responses in an accessible database, as indicated at block 50.

The basic function shown in FIG. 5 may be performed for a single user as shown in FIG. 6. As shown at block 52, multiple responses from the user are processed by the processing system 12. As shown at block 54, the processed data is stored in an accessible database. As shown at block 56, information is derived from the stored data and provided to the user. For example, an awarded return value and related information for accounting and/or tax purposes may be provided to the user.

The information provided to the user may also be a quantified chance that one of the first correct responses input by the particular user will be accessed. The quantified chance may be based upon a total number of users that have input first correct responses to the processing system 12.

As noted above, the processing system 12 has at least the one information database 42. The database 42 may store educational health information that can be accessed through the plurality of end user devices 14. The information may be directly accessed by a user through the device 14. Alternatively, the processing system 12 may link a user to specific information making up a part of the database 42 as an incident of the user's inputting a selection of one of the first and second responses. The information may elaborate further with respect to a correct response or provide educational information in the event of an incorrect response.

The processing system 12 may be configured so that as an incident of accessing the information database 42 directly through the user device 14, as shown at block 58 in FIG. 7, one or more health related inquiries is presented to a user as shown at block 60.

As shown in FIG. 8, by performing steps in a game-type format set up in the processing system 12, as shown at block 62, a user may be led to specific health related inquiries, as shown at block 64, or may be otherwise tied in with the health related inquiries to allow the basic steps described above to be carried out in a more interesting format, which adds further to the basic appeal of the lottery-style format described heretofore.

Specific, exemplary network configurations and processes will now be described using the basic functionality of the network 10, as described above.

Step 1

Registered users will receive a single scratch card 33 with important evidence-based health information in a question and answer format on a daily basis. A new scratch card 33 will be delivered on a home page from the database 43 of health related inquiries. It is anticipated that registered users will visit the home page on a daily basis to play the scratch cards 33, thereby to improve their chance of receiving a cash or other type of award through the lottery-style drawing. A user may be sent a text or email, encouraging him/her to go to the home page.

Step 2

Registered users can digitally “scratch off” an answer/response to a health related question and thereby become entered into a winning lottery-style pool with a correct response. If an incorrect response is selected, they might be entered into a secondary lottery-style pool with a different/lesser value. Whether the user responds to the health related inquiry correctly or incorrectly, they will receive additional information. In the case of an incorrect response, the correct response may be displayed and explained. The user is invited to return at a later time/day to be presented another question. In the case of a correct response, the user may be given additional useful information specifically on the subject matter of the inquiry and/or information on other subject matter that has a meaningful relationship thereto. Those inputting correct and incorrect responses may receive the same level of information and access to additional educational information.

Step 3

Software will randomly select and identify winners of each “lottery-style pool” which is created from the input responses.

Step 4

Winning names will be posted in an “achievements” section and a customized email will be distributed to all participants to announce the winner or winners of the drawing.

Step 5

The network 10 will automatically distribute awards to the winners through email notification.

Step 6

The network 10 will maintain a repository of all winners and will provide all documentation for accounting and tax purposes.

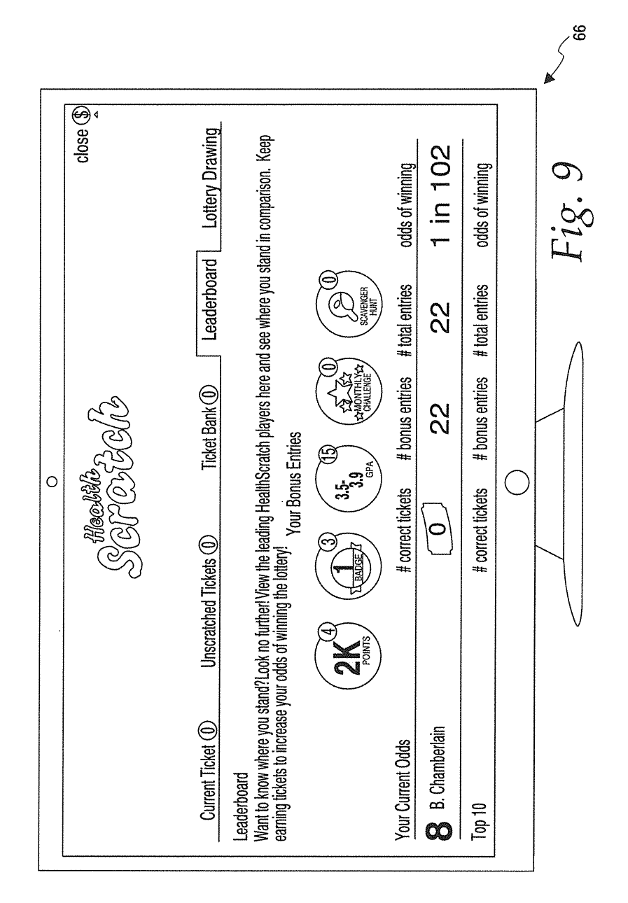

The status of the scratch cards 33 will be displayed through an icon which is located at a platform header next to an assigned user “grade point average” (“GPA”) and “points” status. By clicking on the icon, users will be taken to a leader board, as shown at 66 in FIG. 9, where they can view the status of all scratch cards, to include the number of correctly answered health related inquiries, and a percent chance of winning each lottery-style pool. That odds of winning will be calculated in real time, as by dividing the number of correct and incorrect responses per individual by the number of correct and incorrect responses for all users.

The sponsor, which may be an employer, health plan, government agency, or community health initiative, will determine the amount of financial rewards it wishes to allocate to the lottery, and may also designate the time interval when the lottery-style drawing will take place. If many individuals participate, ultimate financial exposure can remain capped to avoid excessive financial risk on the part of the network operator/sponsor. Health plan administrators may have the capability to modify the amounts of the system awards and the frequency of drawings through an administrative portal. The entity that makes the network capability available to a sponsor may perform this, and other network control services, as part of a provider agreement.

The employer may elect to hold a raffle every week, monthly, quarterly, on a yearly basis, or a combination of all these options. A mega-drawing for a large award could be held at the end of each year.

A percentage of users might be made instant winners of a small award by correctly responding to a single health related inquiry. The instant winner will be immediately congratulated and notified of their award and of a particular value.

The network 10 may have the capability to generate multiple scratch cards each day and to provide users an opportunity to speed up play by increasing the frequency of availability of the scratch cards. This allows them to learn more and increase their chances of winning the lottery. This might be done through an opt-in selection by a user.

The scratch cards can be an integral part of a gamification strategy. For example, the cards might be embedded in specific areas of the site and served up at a time that an individual opens a particular link or participates in a specific activity. Any game format may be employed using a wide range of different rules, point scoring, and competition. The format may be based upon existing games or originally devised.

The network may have the ability to sequentially deliver a string of multiple scratch cards to educate users about complicated concepts. This functionality might occur as within a chronic condition module.

The scratch cards can be played at the time of awarding or be deposited to a card account where they can be played at a later date. The cards may be archived so users can review the questions and answers at any time.

Bonus scratch card opportunities may be provided based on levels of achievement and participation. They may be provided based upon the number of points that have been accumulated during an educational experience or as a result of achieving a certain “grade point average”. As individuals increase their particular status through participation in the network, they might have a greater chance of winning additional cards, thus increasing their knowledge and their chances of winning an eventual award.

The network can be private-labeled and customized to a given sponsor's look and feel. Single sign-on capabilities may allow for seamless integration into other platforms.

Premium value card tickets may be incorporated into the site to provide greater incentives for individuals to participate in high value activities such as surveys and high-impact interactive activities.

The processing system may be accessible using a free, public-facing application that will be downloaded via iTunes® or Android Play Store®. Other dissemination processes are also contemplated. Downloading may result in a user's being given free cards delivered, as to their mobile smart phone, on a daily basis.

Individuals can directly link to other proprietary games to integrate the learning process with the gaming to learn more and accumulate additional cards.

The rights to participate can be licensed to any organization that needs to disseminate important evidence-based health information to target user groups. For example, it might be used by federal and state government programs as a vehicle to disseminate information to the U.S. population and receive feedback from users regarding important health-related information.

Organizations with a need to increase consumer awareness and understanding of credible evidence-based health information can become sponsors and disseminate their information through the scratch cards. Sponsors may be highlighted on a sponsor landing page.

Increasing consumer awareness of critical health issues, improving health literacy, and motivating individuals to learn about critical health issues, are primary objectives of the present invention. Learning theory demonstrates that once awareness about a topic is achieved, curiosity and an interest in learning more will follow. For example, in the case where an employer is the sponsor, the inventive network provides the employer a unique and effective way to motivate its employees so as to allow building of a culture of health and wellness throughout an organization in which users team to manage their care with doctors and mid-level providers. This tends to improve employee loyalty and morale by offering a fun and engaging way to learn about health. By providing financial incentive for educational achievement through a lottery-style format, the invention fosters a culture of health within the organization by: i) increasing awareness; ii) encouraging teamwork; iii) fostering collaboration; iv) stimulating friendly competition; and v) engendering camaraderie. Creating a culture of health within an organization will benefit an employer in numerous ways, notably: a) improving employee loyalty; b) increasing employee productivity; c) improving health of employee; and iv) reducing healthcare costs.

Generally, individuals that participate may make up a unique population that health plan payers would like to target and get access to. They may have a lower socioeconomic status and poorer health status, and therefore are desirably targeted and incentivized to participate in health improvement initiatives.

Elderly individuals within Medicare or Advantage plans are also ideal participants. These individuals will understand the opportunity that this invention gives them for receiving financial rewards. More importantly, the engagement strategy provides a degree of hope and excitement in this population. This may address the loneliness experienced by elderly individuals which has been known to be a significant impediment to achieving appropriate health outcomes. The element of hope and the possibility of winning provides those individuals with a motivational factor that can spill over into their desire to become healthy and engaged in their healthcare.

In FIG. 9, a further functionality of the network 10 is shown in flow diagram form. In FIG. 9, health related inquiries are presented as shown at block 70. The inquiries may be in the nature of requests for information, such as in a survey as part of a Health Risk Assessment (HRA).

As shown at block 72, the processing system is configured to receive responses to the health related inquiries inputted by the user device and equate each response to a value item.

As shown at block 74, the processing system is configured to accumulate the value items in a database.

As shown at block 76, access is gained to one of the value items in the first database based upon predetermined access criteria. A user is associated with the accessed one of the value items.

The same concept can be utilized to motivate persons to respond to inquiries in surveys such as HRAs, Medication Adherence Assessment, depression screenings, and other types of surveys. The user is incentivized to complete the survey by using the value items in a lottery-style system operation, as described above. The user may receive a valuable award simply by participating in the survey. The user will also receive directed educational messages related to their responses.

The invention further contemplates that this same concept could be employed to encourage responses in surveys and activities unrelated to health and health care.

In each of the survey-type operations, value items or their equivalent can be accumulated additionally through a self-reporting feature that results in inputting of information not directly responsive to a health related inquiry.

Many other refinements to the basic network 10 are contemplated. For example, the health related information can be tailored to individuals' personal traits, health, and behavior, based upon a multi-tier assessment, including as one example: a) Literacy Assessment that measures the individual's ability to understand information that will potentially be presented to them; b) Health Risk Assessment that is a comprehensive, self-reporting tool that provides an overall summary of an individual's health status; and c) Medication Adherence Assessment which uses a questionnaire to evaluate an individual's medication-taking behavior and documents factors responsible for inadequate or inappropriate medication-taking behaviors.

Once these assessments are completed, the processing system may re-factor the education, award and incentive schemes for individuals. As more is learned about each user, the standards of behavioral psychology are applied, delivering additional education and motivational activity at the most appropriate time to lead to a true change in health behavior. Other condition-specific assessments (e.g., depression or quality of life) can be added, which would permit even more specific targeting of education.

The foregoing disclosure of specific embodiments is intended to be illustrative of the broad concepts comprehended by the invention.

1. A health information processing network comprising:
a processing system configured to present a first health related inquiry accessible through user devices together with alternative responses to the first health related inquiry including: a) a first correct response to the first health related inquiry; and b) a second incorrect response to the first health related inquiry; and
a plurality of user devices each configured to allow a user to: i) identify the first health related inquiry and alternative responses; and ii) input a selection of one of the first and second responses,
the processing system configured to receive the input selected responses and accumulate each of the input first correct responses with an associated user identity in a first database,
the processing system further configured to: A) provide access to one of the input first correct responses in the first database based upon pre-determined access criteria; and B) identify a user associated with the accessed one of the input first correct responses.

2. The health information processing network according to claim 1 wherein the processing system is configured so that the accessed one of the input first correct responses in the first database is accessed using a random number generator.

3. The health information processing network according to claim 1 wherein the processing system is configured to relate a return awarded to the user associated with the accessed one of the input first correct responses based upon programmed criteria.

4. The health information processing network according to claim 1 wherein the processing system and user devices are configured so that the health related inquiry and first and second responses are displayed on an image of a scratch card.

5. The health information processing network according to claim 3 wherein the return awarded is one of: a) a specific dollar amount; b) a discount on a health insurance premium; c) a discount on a health related product; and d) a discount on a health related service.

6. The health information processing network according to claim 3 wherein the processing system is further configured to accumulate each of the input second incorrect responses with an associated user identity in a second database, the processing system further configured to: a) provide access to one of the input second incorrect responses in the second database based upon predetermined access criteria; b) identify a user associated with the accessed one of the input second incorrect responses; and c) relate a return awarded to the user associated with the accessed one of the input second incorrect responses based upon programmed criteria.

7. The health information processing network according to claim 1 wherein the processing system has a database of information relating to one of: a) general health issues; b) health diagnosis; c) health improvement; and d) health maintenance that is accessible through the plurality of user devices.

8. The health information processing network according to claim 1 wherein the processing system is configured to provide feedback to users of user devices that input a selection of one of the first and second responses relative to subject matter to which the first health related inquiry pertains.

9. The health information processing network according to claim 1 wherein the information processing network is configured to present an additional health related inquiry that is processed through the processing system and plurality of user devices in the same way that the first health related inquiry is processed, the processing system further configured to accumulate an individual user's input first correct responses and assign a status to the individual user based upon a number of the individual user's input first correct responses.

10. The health information processing network according to claim 1 wherein the information processing network is configured to present an additional health related inquiry that is processed through the processing system and plurality of user devices in the same way that the first health related inquiry is processed, the processing system configured to assign a value to a particular user's input first correct responses and the value is different for the input first correct responses to different health related inquiries.

11. The health information processing network according to claim 1 wherein the information processing network comprises a database of health related inquiries and alternative responses, including the first health related inquiry and alternative responses to the first health related response, and the processing system is configured to present multiple health related inquiries and alternative responses from the database either together or separately to be accessible through the user devices.

12. The health information processing network according to claim 9 wherein the processing system is configured to store accumulated data relating to a particular user's input first and second responses to be accessible through one of the plurality of user devices.

13. The health information processing network according to claim 9 wherein the processing system is configured to store accumulated data relating to first and second users input first and second responses and so that the first user can access the accumulated data relating to each of the first and second users' input first and second responses.

14. The health information processing network according to claim 3 wherein the processing system is configured to make available to a user a respective awarded return value and related information for accounting and/or tax purposes.

15. The health information processing network according to claim 1 wherein the processing system is configured so that the predetermined access criteria is based upon a total number of users that have input first correct responses.

16. The health information processing network according to claim 15 wherein the processing system is configured to determine and display a quantified chance that a particular user will be provided access to one of the first correct responses input by the particular user.

17. The health information processing network according to claim 1 wherein the information processing network is configured to store educational health information that can be accessed through the plurality of user devices and so that the first health related inquiry is presented to a particular user as an incident of the particular user's accessing the stored educational health information.

18. The health information processing network according to claim 1 wherein the information processing network is configured to present a number of games that can be played by a user that require a user input that selectively leads to presentation of a health related inquiry.

19. The health information processing network according to claim 1 wherein the information processing network is configured to be accessed by a public-facing application.

20. The health information processing network according to claim 1 wherein the information processing network is configured to store educational health information and the information processing network is configured to link a particular user to specific information making up part of the stored educational health information as an incident of the particular user's inputting a selection of one of the first and second responses.

21. An information processing network comprising:
a processing system configured to present a first inquiry accessible through user devices together with alternative responses to the first inquiry including: a) a first correct response to the first inquiry; and b) a second incorrect response to the first inquiry; and
a plurality of user devices each configured to allow a user to: i) identify the first inquiry and alternative responses; and ii) input a selection of one of the first and second responses,
the processing system configured to receive the input selected responses and accumulate each of the input first correct responses with an associated user identity in a first database,
the processing system further configured to: A) provide access to one of the input first correct responses in the first database based upon pre-determined access criteria; and B) identify a user associated with the accessed one of the input first correct responses.

22. A health information processing network comprising:
a processing system configured to present a first health related inquiry accessible through user devices; and
a plurality of user devices each configured to allow a user to input a response to the first health related inquiry,
the processing system configured to: a) receive the input responses; b) equate each input response to a value item; and c) accumulate the value items in a first database,
the processing system further configured to: A) provide access to one of the value items in the first database based upon predetermined access criteria; and B) identify a user associated with the accessed one of the value items.
